(19) United States
(12) Patent Application Publication
(10) Pub. No.: US 2010/0097524 A1
(43) Pub. Date: Apr. 22, 2010

(54) OPTICAL MEMBER, LIGHTING DEVICE, DISPLAY DEVICE AND TELEVISION RECEIVER

(76) Inventor: Yasumori Kuromizu, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/593,691

(22) PCT Filed: Dec. 3, 2007
(86) PCT No.: PCT/JP2007/073315

§ 371 Date: Sep. 29, 2009

(30) Foreign Application Priority Data
Mar. 30, 2007 (JP) 2007-094448

(51) Int. Cl. H04N 5/44; G02B 5/02; F21V 3/00; F21V 29/02; G02F 1/13357

(52) U.S. Cl. 348/553; 359/599; 362/311.06; 362/294; 349/64; 348/E05.096

(57) ABSTRACT

A diffuser plate 16A includes a plate-shaped base member 23 capable of light transmission. The base member 23 has a construction in which a plurality of tubular units 25 having hole portions 24 are aligned in each of a planar direction and a thickness direction of the base member 23 and are connected to one another. The tubular units 25 aligned in the thickness direction of the base member 23 are arranged by being shifted in the planar direction of the base member 23 from one another. An intermediate position between the tubular units 25 aligned in the planar direction, and a center position of the tubular unit 25 aligned in the thickness direction with respect to the tubular units 25 correspond to each other, and a sectional shape of the hole portion 24 is formed into a regular hexagonal shape. More specifically, the base member 23 has a honeycomb structure.

### TECHNICAL FIELD

The present invention relates to an optical member, an lighting device, a display device and a television receiver.

### BACKGROUND ART

A liquid crystal display device is constructed by a liquid crystal panel and a backlight placed at a rear side of the liquid crystal panel. Among them, the backlight includes a chassis which houses a light source such as cold cathode tubes and has a surface on a light emitting side opened, and an optical member which is placed in the opened portion of the chassis, and has the functions of converting the light emitted from the light source into a uniform planar light and the like.

The optical member includes a diffuser plate having a construction in which a number of diffuser particles are included by being dispersed in a transparent planar base member. The optical member has a construction in which a thin diffusion sheet, a lens sheet and a brightness enhancement sheet are sequentially stacked on the diffuser plate. The diffuser plate has the function of supporting the respective sheets stacked thereon, and therefore, it needs to have rigidity of a certain degree. As one example of the diffuser plate, the one described in the following Patent Document 1 is known.

### Patent Document Japanese Patent Laid-Open No. 2006-259736

### DISCLOSURE OF THE INVENTION

### Problems to be Solved by the Invention

Incidentally, in recent years, the screen sizes of liquid crystal display devices have been increased. With this, the members in use also have increased in size, and there arises the problem that the weight of the entire liquid crystal display device becomes too heavy. Above all, in the diffuser plate constituting an optical member, if the longitudinal and lateral dimensions become large correspondingly to the screen size, the required rigidity becomes high correspondingly, and therefore, the thickness dimension needs to be increased. Specifically, increase in the screen size increases the capacity of the diffuser plate in order to ensure the area and rigidity corresponding to it, and results in significant increase in the weight of the diffuser plate.

Further, the diffuser particles included in the diffuser plate have the property of diffusing more lights in a short wavelength region among visible lights emitted from the light source. Therefore, when the thickness dimension of the diffuser plate becomes large, the visible lights transmitting through the diffuser plate include relatively more lights in the long wavelength region, and there arises the problem that yellowish light is visually recognized as a result.

The present invention is completed based on the circumstances as described above, and has an object to provide an optical member preferable for increase in size.

### Means for Solving the Problems

The present invention includes a plate-shaped base member capable of light transmission, and the base member has a construction in which a plurality of tubular units having hole portions are aligned in each of a planar direction and a thickness direction of the aforesaid base member and are connected to one another.

The base member is constructed by a congregation of the tubular units having the hole portions like this, and therefore, even if the size is increased, reduction in weight can be achieved while rigidity is ensured.

As embodiments of the present invention, the following constructions are preferable.

(1) Such a construction is adopted, in which the aforesaid hole portions in the aforesaid respective tubular units are formed into the same shape, and the aforesaid respective tubular units are arranged to be aligned parallel with one another. In this manner, arrangement efficiency of the hole portions in the base member can be made favorable, which is preferable for further reduction in weight, and manufacture is facilitated.

(2) The aforesaid tubular units aligned in the aforesaid thickness direction are constructed to be arranged by being shifted in the aforesaid planar direction from one another. In this manner, the structure is adopted, in which to the region located between the hole portions adjacent in the planar direction in the base member, the hole portions are adjacent in the thickness direction. Therefore, rigidity can be kept high, and brightness unevenness hardly occurs when light is transmitted.

(3) A construction is adopted, in which an intermediate position between the aforesaid tubular units aligned in the aforesaid planar direction, and a center position of a tubular unit aligned in the aforesaid thickness direction with respect to the tubular units are arranged to correspond to each other. In this manner, higher rigidity can be ensured, and brightness unevenness more hardly occurs when light is transmitted.

(4) The aforesaid tubular unit is constructed to have the aforesaid hole portion which is substantially hexagonal in section. In this manner, the base member is of a so-called honeycomb structure. Therefore, the arrangement efficiency of the hole portions in the base member becomes further favorable, and an extremely high effect in weight reduction can be obtained.

(5) The aforesaid tubular unit is constructed to be formed so that a side edge of the aforesaid hole portion is parallel with a plate surface of the aforesaid base member. In this manner, the tubular unit is preferable for a thin base member.

(6) The aforesaid tubular unit is constructed to have the aforesaid hole portion which is substantially triangular in section. In this manner, the arrangement efficiency of the hole portions in the base member becomes favorable, and a high effect in weight reduction can be obtained.

(7) The aforesaid tubular unit is constructed to have the aforesaid hole portion which is substantially quadrangular in section. In this manner, the arrangement efficiency of the hole portions in the base member becomes favorable, and a high effect in weight reduction can be obtained.

(8) The aforesaid tubular unit is constructed to have the aforesaid hole portion which is substantially circular in section. In this manner, when the base member is manufactured by resin-molding, the pin of the molding die becomes circular correspondingly to the hole portion, and therefore, die strength can be kept high.

(9) The aforesaid tubular unit has a construction in which it has the aforesaid hole portion which is substantially elliptical in section, and the aforesaid tubular unit in its long axis direction is formed to be parallel with a plate surface of the aforesaid base plate. In this manner, when the base member is manufactured by resin-molding, the pin of the molding die is in an elliptical shape correspondingly to the hole portion, and therefore, die strength can be kept high. In addition, the tubular unit becomes preferable for a thin base member.

(10) A construction is adopted, in which the aforesaid base member is formed into a rectangular shape, and an axial direction of the aforesaid tubular unit corresponds to a short side direction of the aforesaid base member. In this manner, as compared with, for example, the case where the axial direction of the tubular unit is caused to correspond to the long side direction of the base member, the length dimension of the tubular unit can be made short, and therefore, manufacture is facilitated.

(11) The aforesaid tubular unit is constructed to have the aforesaid hole portion in a form penetrating through the aforesaid base member. In this manner, air can be circulated in the base member.

(12) The aforesaid base member has a construction in which a number of diffuser particles are included by being dispersed. The diffuser particles have the property that diffuses more lights in the short wavelength region among visible lights, but the thickness of the tubular unit constituting the base member depends on the space between the hole portions, and has nothing to do with the thickness dimension of the base member. Therefore, the problem that the transmitted light becomes yellowish as the thickness dimension of the base member increases can be avoided.

(13) The aforesaid optical member has a structure in which the aforesaid tubular unit has the aforesaid hole portion in a form penetrating through the aforesaid base member, and has a construction in which a ventilation passage which communicates with the hole portion is ensured. In this manner, air can be circulated to the hole portions penetrating through the base member from the ventilation passage, and heat can be removed from the optical member.

(14) A construction is adopted, in which the axial direction of the aforesaid tubular unit is set to be parallel with a vertical direction in a use state. In this manner, the air warmed in the process of passing through the hole portions is efficiently exhausted, and circulation performance of air becomes favorable, and favorable heat removal efficiency is obtained.

(15) The aforesaid ventilation passage is constructed to include a blowing device capable of blowing air toward the aforesaid hole portion. In this manner, air can be forcefully circulated to the hole portions by the blowing device, and therefore, favorable heat removal efficiency is obtained.

### ADVANTAGE OF THE INVENTION

According to the present invention, an optical member preferable for increase in size can be provided.

### BRIEF DESCRIPTION OF THE DRAWINGS

FIG. 1 is an exploded view showing an outline of a television receiver according to embodiment 1 of the present invention;

FIG. 2 is an exploded perspective view expressing an outline of a liquid crystal display device;

FIG. 3 is a sectional view of the liquid crystal display device cut along a long side direction;

FIG. 4 is a sectional view of the liquid crystal display device cut along the short side direction;

FIG. 5 is a plane view of a diffuser plate;

FIG. 6 is a sectional view showing a state in which a molding die for manufacturing the diffuser plate is closed;

FIG. 7 is a sectional view showing a state in which a synthetic resin material is filled in the molding die;

FIG. 8 is an enlarged sectional view of a diffuser plate according to example 1 cut along the long side direction;

FIG. 9 is an enlarged sectional view of the diffuser plate according to example 1 cut along the short side direction;

FIG. 10 is an enlarged sectional view of a diffuser plate according to example 2 cut along the long side direction;

FIG. 11 is an enlarged sectional view of a diffuser plate according to example 3 cut along the long side direction;

FIG. 12 is an enlarged sectional view of a diffuser plate according to example 4 cut along the long side direction;

FIG. 13 is an enlarged sectional view of a diffuser plate according to example 5 cut along the long side direction;

FIG. 14 is an enlarged sectional view of a diffuser plate according to example 6 cut along the long side direction;

FIG. 15 is an enlarged sectional view of a diffuser plate according to example 7 cut along the long side direction;

FIG. 16 is an enlarged sectional view of a diffuser plate according to example 8 cut along the long side direction;

FIG. 17 is an enlarged sectional view of a diffuser plate according to example 9 cut along the long side direction;

FIG. 18 is a sectional view of a liquid crystal display device according to embodiment 2 of the present invention cut along the short side direction;

FIG. 19 is a sectional view of a liquid crystal display device according to embodiment 3 of the present invention cut along the short side direction;

FIG. 20 is an enlarged sectional view of a diffuser plate according to embodiment 4 of the present invention cut along the long side direction;

FIG. 21 is an enlarged sectional view showing the state before respective sheet members are bonded to one another;

FIG. 22 is an enlarged sectional view of a diffuser plate according to embodiment 5 of the present invention cut along the long side direction; and

FIG. 23 is a plane view of a diffuser plate according to another embodiment (1).

### DESCRIPTION OF SYMBOLS

10, 26 BACKLIGHT (LIGHTING DEVICE)
11 LIQUID CRYSTAL PANEL (DISPLAY PANEL)
13, 30 CHASSIS
15 COLD CATHODE TUBE (LIGHT SOURCE)
16 OPTICAL MEMBER
16A, 46, 53, 60 DIFFUSER PLATE (OPTICAL MEMBER)
23, 47, 54 BASE MEMBER
24, 49, 56, 59 HOLE PORTION
25, 48, 55 TUBULAR UNIT
33, 45 VENTILATION PASSAGE
39, 40 FAN (BLOWING DEVICE)
D, D′, D″ LIQUID CRYSTAL DISPLAY DEVICE

### BEST MODE FOR CARRYING OUT THE INVENTION

### Embodiment 1

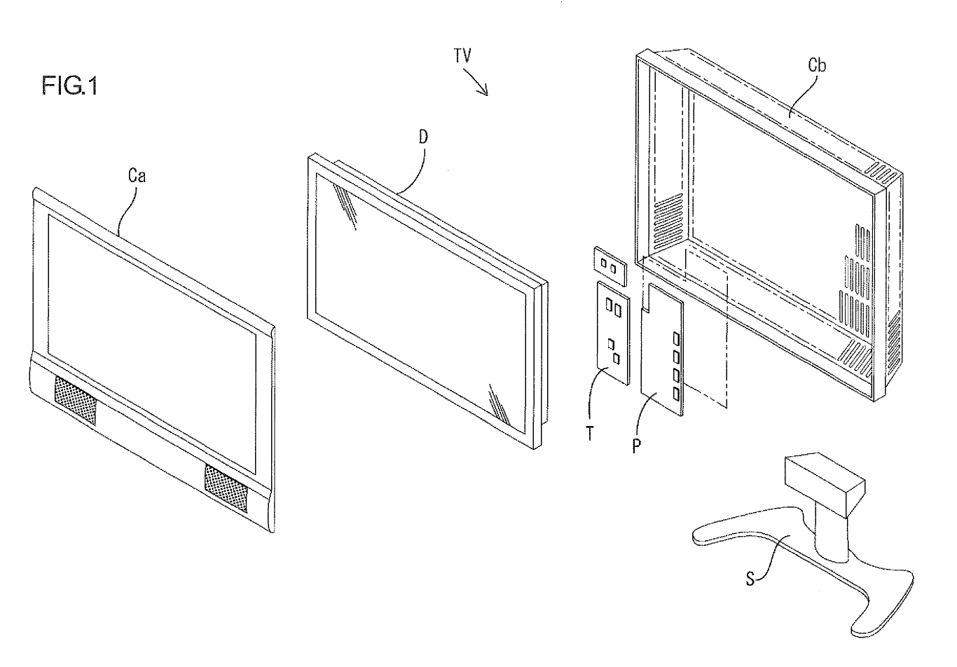

An embodiment 1 according to the present invention will be explained with reference to FIGS. 1 to 17. In the embodiment 1, a liquid crystal display device D as a display device will be illustrated.

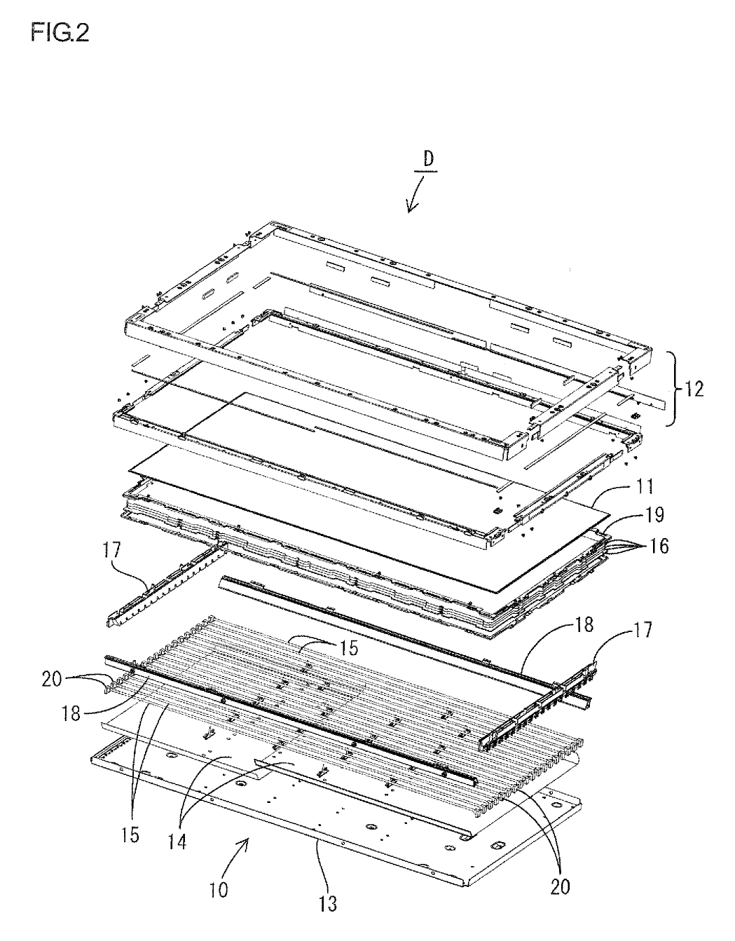

Referring to FIG. 2, the liquid crystal display device D forms a horizontally-long rectangular shape as a whole, in which a liquid crystal panel 11 as a display panel and a backlight 10 as an external light source (or a lighting device) for the liquid crystal panel 11 are held together by a bezel 12 arranged to cover the front side thereof. The liquid crystal panel 11 is disposed on the front side of the backlight 10, so that the backlight 10 can illuminate the liquid crystal panel 11 from the back side. The liquid crystal display device D can be applied. to a television receiver TV. As shown in FIG. 1, the television receiver TV includes the liquid crystal display device D, and front and back cabinets Ca and Cb capable of holding the liquid crystal display device D therebetween. Further included are a power source P, a tuner T and a stand S.

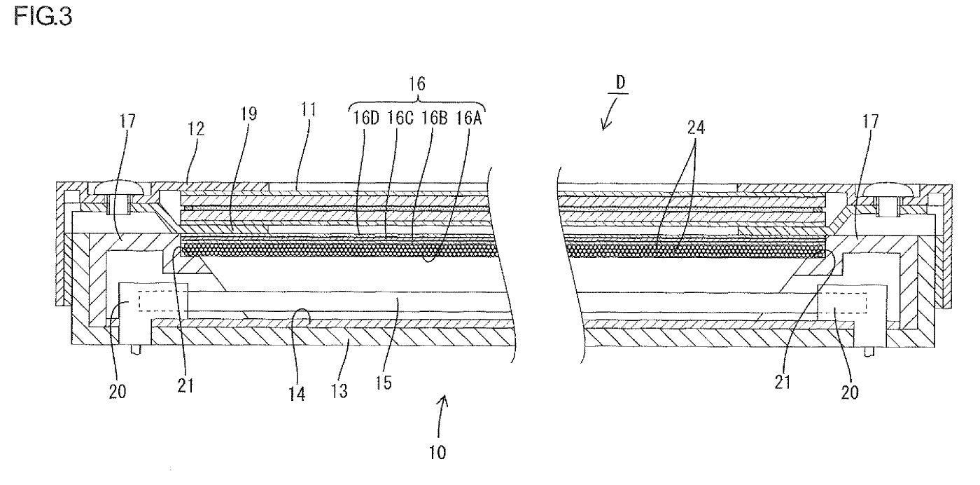

The liquid crystal panel 11 has a well-known construction, in which the gap between a transparent TFT substrate and a transparent CF substrate is filled with liquid crystal as a material with an optical property that changes with applied voltage, as shown in FIG. 3. TFTs (Thin Film Transistors), as switching elements connected to source wiring lines and gate wiring lines running at right angles to each other, are provided on the TFT substrate. A color filter, on which color sections of three primary colors, i.e., Red (R), Green (G) and Blue (B), are arranged in a matrix, is provided on the CF substrate. Further, on each of the substrates, a polarizing plate is attached to its surface on the opposite side of the liquid crystal side.

The backlight 10 is a so-called direct-light type, which includes a chassis 13 having an opening on its obverse side (i.e., front side or upper side in FIGS. 2 and 3), reflective sheets 14 with which the chassis 13 is lined, a plurality of cold cathode tubes 15 contained in the chassis 13, optical members 16 arranged on the light emitting side of the cold cathode tubes 15 so as to cover in the opening of the chassis 13, as shown in FIG. 2. Further included are positioning members (including lamp holders 17, holders 18 and a frame 19 described below), which are provided to enable positioning of the optical members 16.

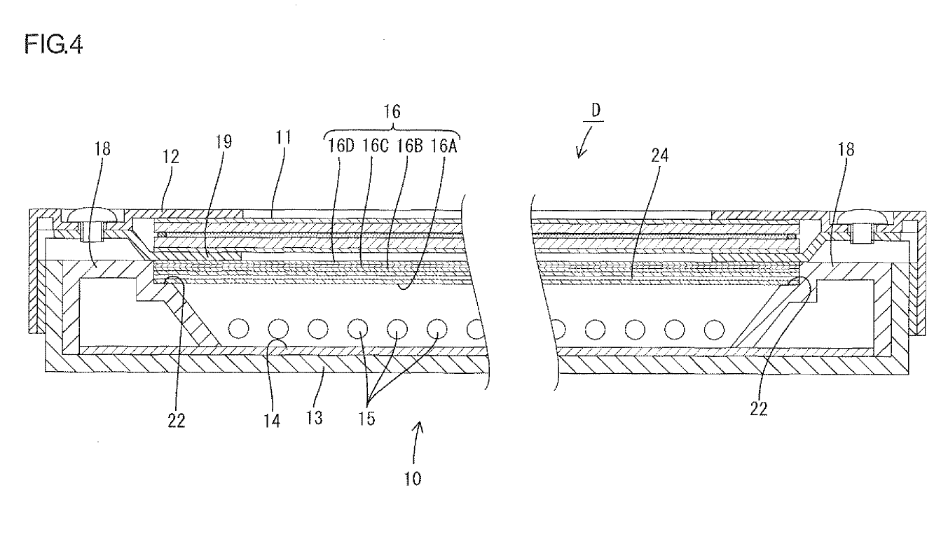

The chassis 13 is made of metal, and forms a substantially box-like shape with open front as shown in FIGS. 3 and 4, which has a rectangular shape when viewed planarly. The reflective sheets 14 are made of synthetic resin, and the front surfaces thereof are colored with white or a color similar to white so as to have superior reflexibility. The reflective sheets 14 are laid in the chassis 13 so as to cover almost the entire area of the inner surface. The reflective sheets 14 can guide the lights from the cold cathode tubes 15 to the opening side of the chassis 13. Each cold cathode tube 15, which is a kind of linear light source, is mounted in the chassis 13 so that the axial direction thereof conforms with the long-side direction of the chassis 13. The plurality of cold cathode tubes 15 are arranged at predetermined intervals so that the axes thereof are substantially parallel to one another. Rubber holders 20 are fitted onto the two respective end portions of each cold cathode tube 15. The rubber holders 20 can be fitted into respective mounting holes provided on the chassis 13, and thereby the cold cathode tubes 15 can be mounted to the chassis 13.

The positioning members include lamp holders 17 and holders 18, which are arranged to form a frame-like support member for supporting the peripheral edge portions of the optical members 16 from the back side. The positioning members further include a frame 19, which is arranged on the front side of the optical members 16 so as to form a frame-like holding member for holding the peripheral edge portions of the optical members 16.

The lamp holders 17 are made of synthetic resin, and the surfaces thereof are colored with white or a color similar to white so as to have superior reflexibility. Referring to FIGS. 2 and 3, the lamp holders 17 are a pair of lamp holders, which are mounted to the two respective long-side-directional ends of the chassis 13 so as to extend along the short-side direction of the chassis 13. The lamp holders 17 each have a substantially box-like shape with open back, which are arranged on the front side of the rubber holders 20 attached to the cold cathode tubes 15, so as to collectively cover the rubber holders 20. A support portion 21 capable of supporting the optical members 16 is provided as a stepped or depressed portion on the inner edge portion of the front surface of each lamp holder 17.

The holders 18 are made of synthetic resin, and the surfaces thereof are colored with white or a color similar to white so as to have superior reflexibility. Referring to FIGS. 2 and 4, the holders 18 are a pair of holders, which are mounted to the two respective short-side-directional ends of the chassis 13 so as to extend along the long-side direction of the chassis 13. A support portion 22 for the optical members 16, similar to that of the lamp holder 17, is provided as a stepped or depressed portion on the inner edge portion of the front surface of each holder 18.

The frame 19 is made of metal to have a frame-like shape, which can be arranged on the front side of the optical members 16 so as to hold all round the peripheral edge portions thereof, as shown in FIGS. 3 and 4. A holding surface facing the planar surface of the optical member 16 is provided on the inner edge portion of the frame 19. The holding surface can be arranged so that a small clearance space is left between the holding surface and the front surface of a brightness enhancement sheet 16D as the topmost optical member. The clearance space allows thermal expansion or contraction of the optical members 16.

Referring to FIG. 2, the optical members 16 each have a rectangular shape, when viewed planarly, similarly to the chassis 13 or the liquid crystal panel 11. The optical members 16 are made of synthetic resin capable of light transmission, and are arranged between the liquid crystal panel 11 and the cold cathode tubes 15 so as to cover in the opening of the chassis 13. The optical members 16 include a diffuser plate 16A, a diffusing sheet 16B, a lens sheet 16C and a brightness enhancement sheet 16D, in this order from the back side (i.e., from the rear side or lower side in FIGS. 3 and 4), which are arranged in a stack. The optical members 16 have functions such as a function for converting lights from the cold cathode tubes 15 as linear light sources into uniform flat lights.

Among them, the diffuser plate 16A which is arranged on the undermost side has a sufficiently large thickness dimension as compared with the other sheets 16B to 16D, and obtains relatively high rigidity, and thereby can support the other sheets 165 to 16D on the underside. The diffuser plate 16A is formed to be translucent as a whole by including a number of diffuser particles not illustrated in a transparent plate-shaped base member 23 made of a synthetic resin by diffusing them. The diffuser plate 16A has the function of making the lamp image difficult to see by diffusing the transmitted light in random directions by the diffuser particles included in the base member 23.

Incidentally, in recent years, in the liquid crystal display device D of the construction described above, increase in the screen size has been advanced, and with this, the various members in use have been increased in size. Therefore, there arises the problem that the weight of the entire liquid crystal display device D becomes too heavy. Among them, in the diffuser plate 16A constituting the optical member 16, as the longitudinal and lateral dimensions become large correspondingly to the screen size, the required rigidity becomes high correspondingly, and therefore, the thickness dimension needs to be increased. Specifically, increase in the screen size results in increase in the capacity of the diffuser plate 16A in order to ensure the area and rigidity corresponding to increase in size, and significant increase in the weight of the diffuser plate 16A.

Further, since the diffuser particles included in the diffuser plate 16A have the property of diffusing more lights in the short wavelength region among visible lights emitted from the cold cathode tubes 15. Therefore, when the thickness dimension of the diffuser plate 16A becomes large, the visible lights transmitting through the diffuser plate 16A include relatively more lights in a long wavelength region, as a result of which, there arises the problem that yellowish light is visually recognized.

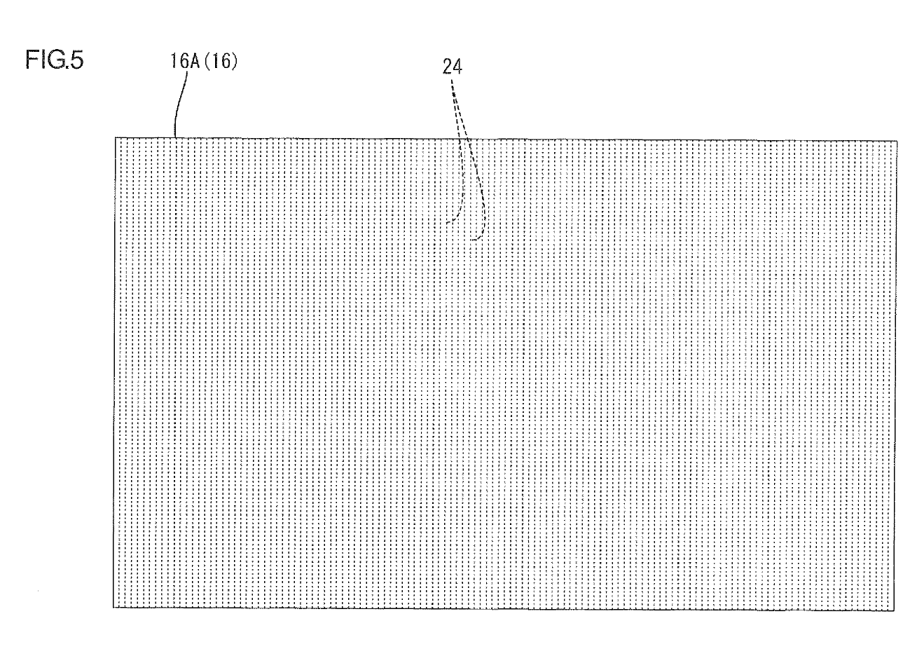

Thus, in the present embodiment, as shown in FIG. 5, innumerable hole portions 24 are formed in the base member 23 of the diffuser plate 16A. In more detail, the hole portion 24 penetrates through the base member 23 along the short side direction (planar direction), and opens to both end surfaces (both upper and lower end surfaces shown in FIG. 5) at the side of the long side of the outer perimeter end surface of the base member 23. A number of hole portions 24 are aligned in the long side direction (planar direction) in the base member 23, and a plurality of the hole portions 24 are also aligned in the thickness direction so as to be regularly placed. In other words, the base member 23 of the diffuser plate 16A is constructed by the congregation of tubular units 25 (tubular hole edge portions around the hole portions 24) each having the hole portion 24 and making the short side direction correspond to the axial direction of the base member 23, and is constructed so that a plurality of tubular units 25 are aligned in each of the planar direction and thickness direction of the base member 23 and connected to one another. The tubular unit 25 mentioned here expresses the conceptual construction unit of the base member 23, and such a component does not actually exist.

When a light is irradiated to the diffuser plate 16A, the light is diffused by the diffuser particles in the process of transmitting through the base member 23, and in addition, the light is diffracted and scattered in the interface of the air layer of the hole portion 24 and the base member 23 (tubular unit 25). Therefore, the diffuser plate 16A is excellent in light diffusing performance.

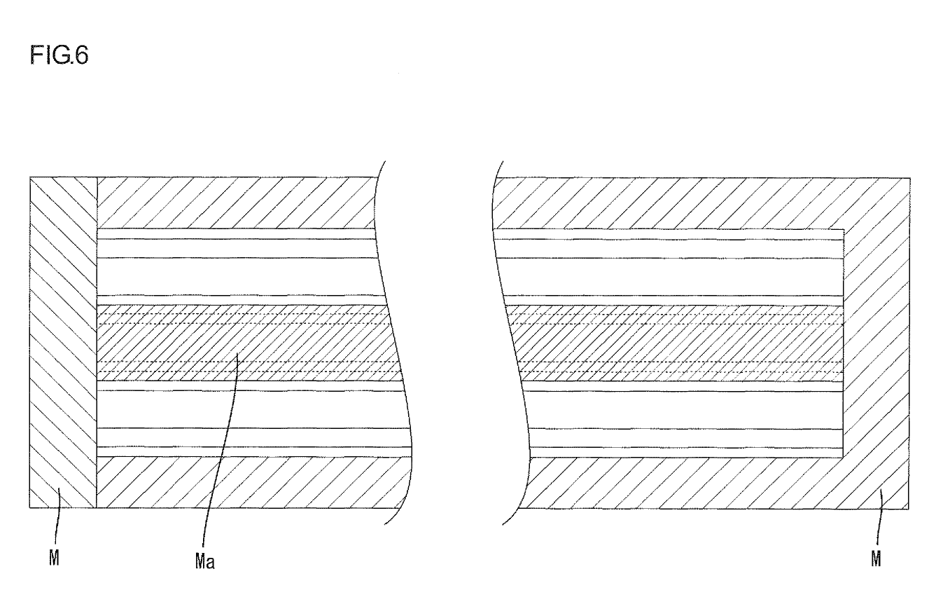

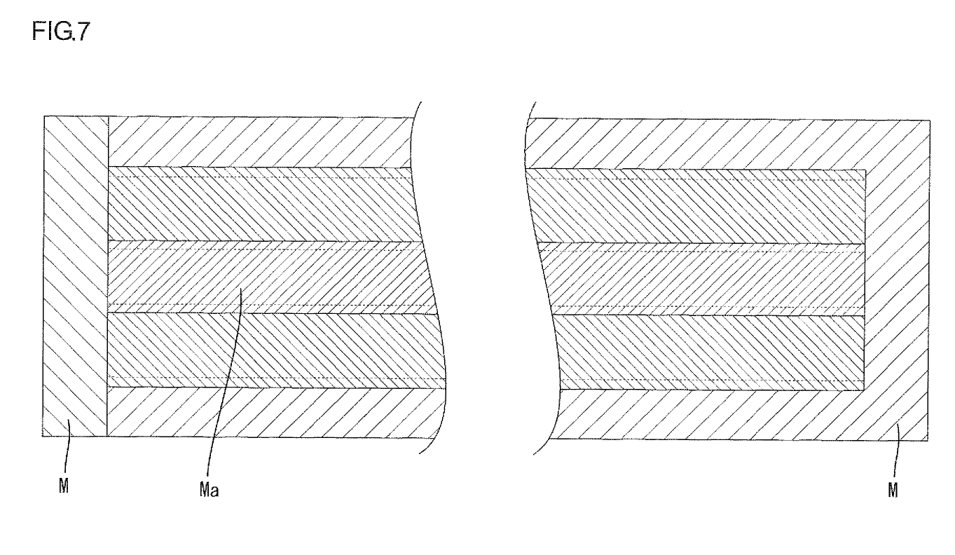

The diffuser plate 16A described above is manufactured by using a molding die M as shown in FIG. 6. The molding die has pins Ma in the shape corresponding to the respective hole portions 24 in the state in which they are protruded into a molding space of the base member 23. The pin is formed into a slim bar shape extending along an opening direction of the molding die, that is, the planar direction of the diffuser plate 16A, and a number of the pins Ma are placed in the positions corresponding to the respective hole portions 24. In the manufacture process, after the synthetic resin material in a molten state including diffuser particles is filled in the above described molding die as shown in FIG. 7, the synthetic resin material is cooled and solidified. Thereafter, the molding die is opened along the planar direction of the diffuser plate 16A, and thereby, the diffuser plate 16A having the hole portions 24 can be obtained.

As the concrete example of the tubular unit 25 which constitutes the base member 23, those in the following shapes are cited. In the following, when the diffuser plates shown in respective examples are to be distinguished from those in the other examples, the numbers of the respective examples are assigned as subscripts to the reference numerals concerning the diffuser plates, and when those in the respective examples are not to be distinguished from one another, the subscripts are not assigned.

### Example 1

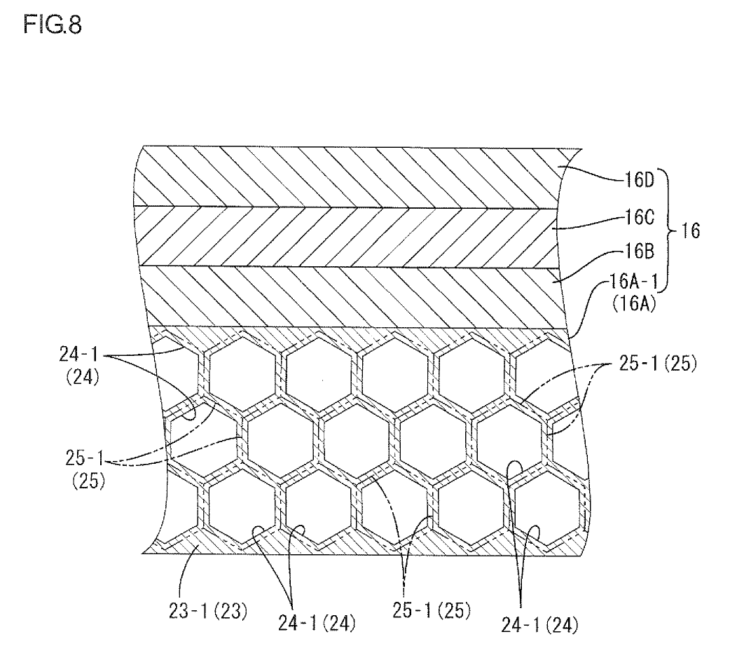

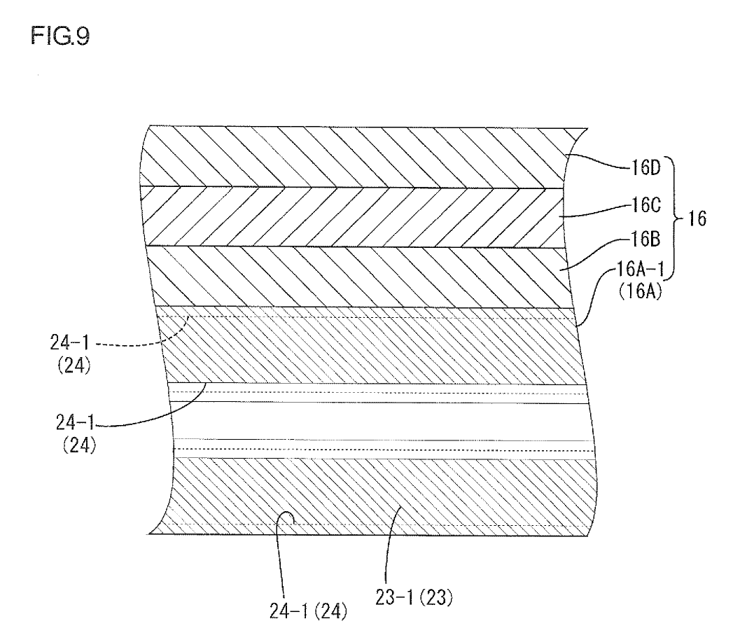

In a diffuser plate 16A-1 according to example 1, each tubular unit 25-1 (shown by the two-dot chain line in FIG. 8) is formed into a tubular shape with a regular hexagonal section as a whole as shown in FIGS. 8 and 9. The inner peripheral surface of the tubular unit 25-1, that is, the sectional shape of a hole portion 24-1 is formed into a regular hexagonal shape. A number of the tubular units 25-1 are aligned along a long side direction (planar direction, the lateral direction shown in FIG. 8) of the base member 23-1, and connected to one another, and thereby, a layer is formed. Subsequently, a plurality (three layers in FIG. 8) of the layers are stacked in a thickness direction (vertical direction shown in FIG. 8) of the base member 23-1, and thereby the base member 23-1 is constructed.

The tubular units 25-1 which are aligned in the thickness direction of the base member 23-1 are arranged by being shifted in the long side direction (planar direction) of the base member 23-1 from one another. In more detail, the shift amount in the long side direction of the tubular units 25-1, which are aligned in the thickness direction of the base member 23-1, is set to about half the width dimension of the tubular unit 25-1. In other words, the intermediate position between the tubular units 25-1 (hole portions 24-1) aligned in the long side direction of the base member 23-1, and the center position of the tubular unit 25-1 (hole portion 24-1) aligned in the thickness direction with respect to the tubular units 25-1 correspond to each other. Namely, the base member 23-1 is of a so-called a honeycomb structure as a whole, the percentage of the entire volume of the hole portions 24-1 in the entire volume of the base member 23-1 is a high percentage of, for example, about 90%. In other words, the respective tubular units 25-1 (respective hole portions 24-1) are in a zigzag arrangement (so that the layers partially overlap in the planar direction) in which the layers aligned along the long side direction of the base member 23-1 are fitted in a staggered configuration.

The hole portion 24-1 of the tubular unit 25-1 is formed so that its side edge (one side of the inner peripheral surface) includes the side edge oriented orthogonally to the plate surface of the base member 23-1. In other words, the hole portion 24-1 is formed to be oriented so that the angles formed. by the lines connecting the center position and respective peaks, and the plate surface of the base member 23-1 become 90 degrees or 30 degrees. The side edges of the adjacent hole portions 24-1 are formed to be parallel with each other, and the thickness (the region arranged between the adjacent hole portions 24-1 of the base member 23) of the tubular unit 25-1 which is arranged between the adjacent hole portions 24-1 is set to be substantially constant over the entire region. Accordingly, on resin-molding of the diffuser plate 16A-1, flowability of the molten synthetic resin material in the molding die becomes favorable, and sink hardly occurs at the time of solidification. In the diffuser plate 16A-1, the region, which is arranged between the hole portions 24-1 adjacent to each other in the long side direction, of the base member 23-1 is made parallel with the thickness direction, and the region, which is arranged between the hole portions 24-1 adjacent (obliquely adjacent) to each other in the thickness direction, is inclined with respect to the thickness direction and the long side direction. The regions parallel in the thickness direction and the regions inclined in the thickness direction are alternately connected.

The base member 23-1 is of a honeycomb structure like this, and a gap hardly exists between the adjacent tubular units 25-1. Therefore, arrangement efficiency of the tubular units 25-1 and the hole portions 24-1 is extremely favorable. Thereby, high rigidity can be maintained, and only a small amount of the synthetic resin material for use is required so that an extremely high effect in weight reduction can be obtained.

### Example 2

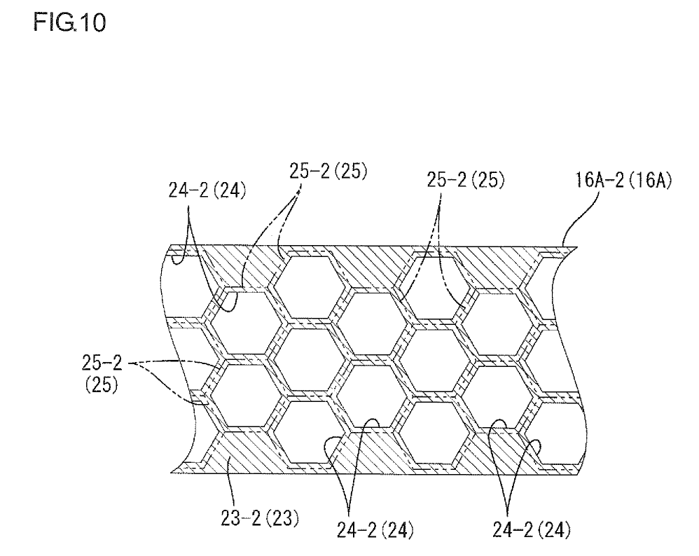

In a diffuser plate 16A-2 according to example 2, the shape of each tubular unit 25-2 (shown by the two-dot chain line of FIG. 10) is made regular hexagonal in section as in the above described example 1, but the orientation of it is changed to the orientation that is the result of turning the one in example 1 by 90 degrees as shown in FIG. 10.

The tubular unit 25-2 is formed so that the side edge (one side of the inner peripheral surface) of a hole portion 24-2 includes the one parallel with the plate surface of the base member 23-2. In other words, the hole portion 24-1 shown in example 1 has such an orientation that a regular hexagon is raised, whereas the hole portion 24-2 shown in example 2 is in such an orientation that the regular hexagon is laid. Description of the structures (arrangements), operations and the like which are the same as those in the above described example 1 will be omitted.

The tubular unit 25-2 is formed so that the side edge of the hole portion 24-2 is parallel with the plate surface of the base member 23-2 like this, and therefore, as compared with the case in which the side edge of the hole portion 24-1 is orthogonal to the plate surface of the base member 23-1 as in example 1, the base member 23-2 can be made thinner than in example 1. Specifically, this is preferable for a thin type diffuser plate 16A-2.

### Example 3

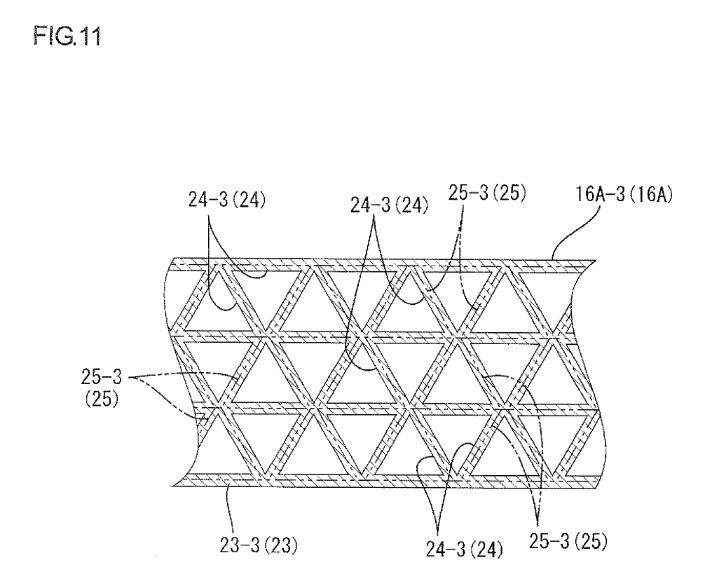

In a diffuser plate 16A-3 according to example 3, each tubular unit 25-3 (shown by the two-dot chain line in FIG. 11) forms a tubular shape with a substantially regular triangle section, and the sectional shape of the hole portion 24-3 is made a regular triangle as shown in FIG. 11. In more detail, the tubular unit 25-3 is formed so that the side edges of the hole portion 24-3 include the one parallel with the plate surface of the base member 23-3, and the ones adjacent in the long side direction (planar direction) are opposite to each other.

The base member 23-3 has the structure in which the region between the layers of the tubular units 25-3, which are aligned along the long side direction, forms a substantially plate shape along the planar direction, whereas the region between the hole portions 24-3, which are adjacent in the long side direction, is in a beam shape inclined with respect to the thickness direction and the planar direction to be connected to the above described plate-shaped region.

In this manner, the arrangement efficiency of the tubular unit 25-3 and the hole portions 24-3 can be made equivalent to that of the above described example 1, and a high effect in weight reduction can be obtained. Description of the structures (arrangements), operations and the like which are similar to those of the above described example 1 will be omitted.

### Example 4

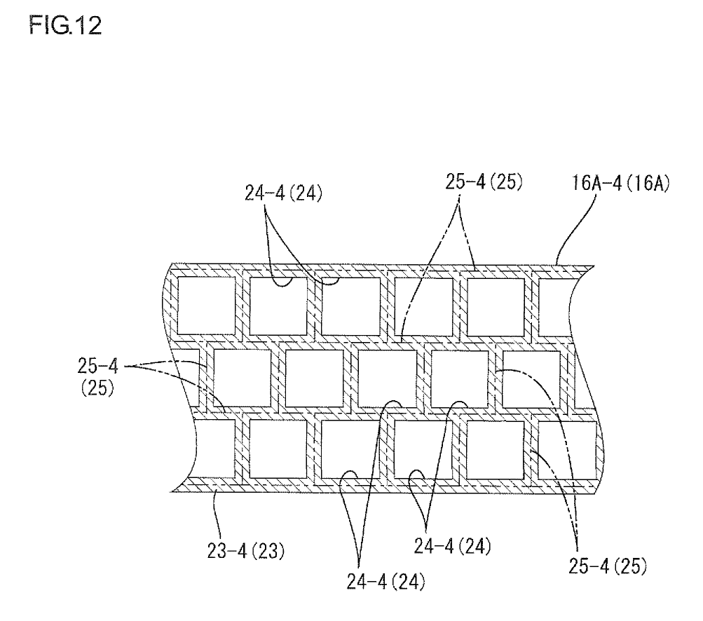

In a diffuser plate 16A-4 according to example 4, each tubular unit 25-4 (shown by the two dot chain line of FIG. 12) forms a tubular shape with a regular quadrangular section, and the sectional shape of a hole portion 24-4 is made a regular quadrangular shape, as shown in FIG. 12. In more detail, in the tubular unit 25-4, the side edges of the hole portion 24-4 include the one parallel with the plate surface of the base member 23-4, and all the tubular units 25-4 are formed in the same orientation.

This base member 23-4 has the structure in which the region between the layers of the tubular units 25-4, which are aligned along the long side direction, forms a substantially plate shape along the planar direction, whereas the region between hole portions 24-4, which are adjacent in the long side direction, is formed into a beam shape parallel along the thickness direction to be connected to the above described plate-shaped region.

In this manner, the arrangement efficiency of the tubular unit 25-4 and the hole portion 24-4 can be made equivalent to those of the above described example 1 and example 3, and a high effect in weight reduction can be obtained. In addition, the orientations of all the tubular units 25-4 (hole portion 24-4) are the same, and therefore, the shape of the base member 23-4 can be simplified. Description of the structures (arrangements), operations and the like which are similar to those of the above described example 1 will be omitted.

### Example 5

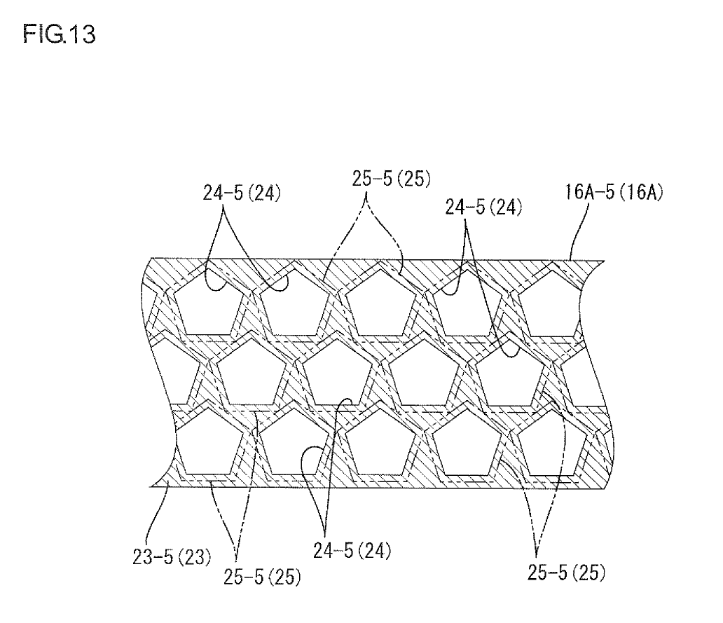

In a diffuser plate 16A-5 according to example 5, each tubular unit 25-5 (shown by the two-dot chain line of FIG. 13) forms a tubular shape with a regular pentagonal section, and the sectional shape of a hole portion 24-5 of it is made a regular pentagonal shape as shown in FIG. 13.

In the diffuser plate of such a structure, the weight of the diffuser plate 16A-5 can be reduced by the amount corresponding to formation of the hole portions 24-5 while rigidity is maintained. Description of the structures (arrangements), operations and the like which are similar to those of the above described example 1 will be omitted.

### Example 6

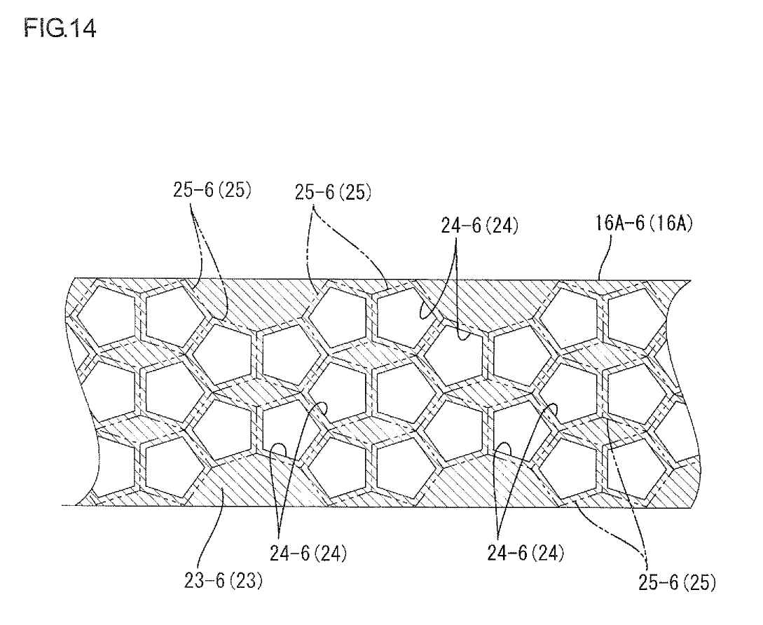

In a diffuser plate 16A-6 according to example 6, each tubular unit 25-6 (shown by the two-dot chain line of FIG. 14) which forms a tubular shape with a regular pentagonal section, and a hole portion 24-6 with a regular pentagonal sectional shape are included as in the above described example 5, but the arrangement is as shown in FIG. 14.

In more detail, the tubular unit 25-6 is arranged so that the side edge of the hole portion 24-6 forms parallelism with the side edge of the hole portion 24-6 of the adjacent tubular unit 25-6, and the side edges of the hole portion 24-6 include the one oriented to be orthogonal to the plate surface of the base member 23-6 as shown in FIG. 14. In each of the region in the upper half of the base member 23-6 and the region in the lower half, four of the tubular units 25-6 are arranged in a sector shape, and two of the tubular units 25-6 are arranged side by side between the sector-shaped tubular unit 25-6 groups.

In the one having such a structure, the weight of the diffuser plate 16A-6 can be reduced by the amount corresponding to formation of the hole portions 24-6 while rigidity is maintained. Description of the structures, operations and the like which are similar to those of the above described example 1 will be omitted.

### Example 7

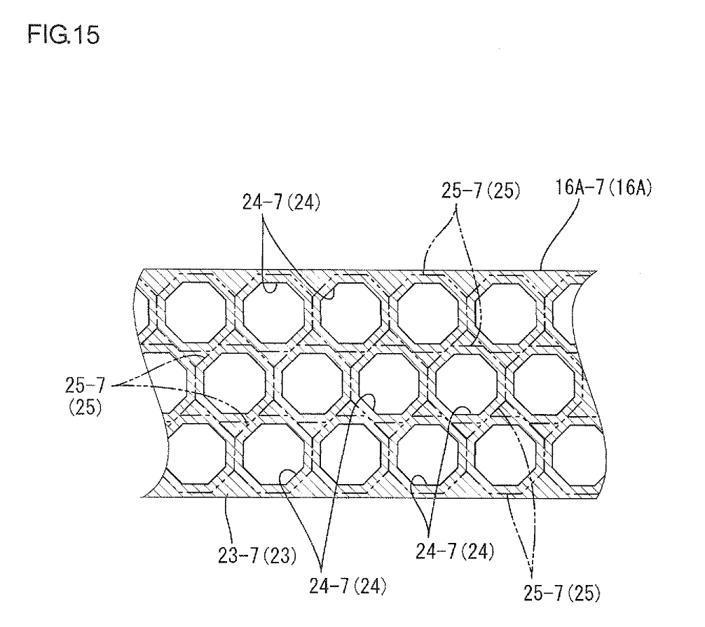

In a diffuser plate 16A-7 according to example 7, each tubular unit 25-7 (shown by the two-dot chain line of FIG. 15) forms a tubular shape with a regular octagonal section, and the sectional shape of a hole portion 24-7 of it is made a regular octagonal shape, as shown in FIG. 15.

In the one having such a structure, the weight of the diffuser plate 16A-7 can be reduced by the amount corresponding to formation of the hole portions 24-7 while rigidity is maintained. Description of the structures (arrangements), operations and the like which are similar to those of the above described example 1 will be omitted.

### Example 8

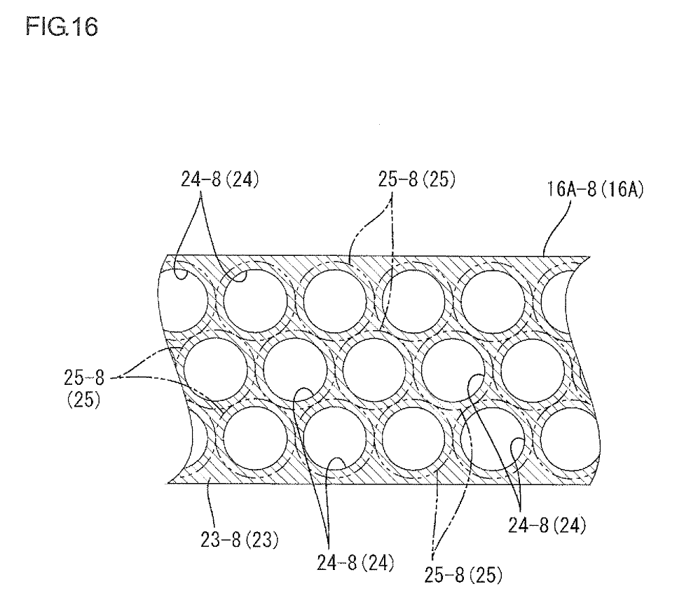

In a diffuser plate 16A-8 according to example 8, each tubular unit 25-8 (shown by the two-dot chain line of FIG. 16) forms a tubular shape with a circular section, and the sectional shape of a hole portion 24-8 of it is formed to be circular, as shown in FIG. 16.

According to such a structure, the pin corresponding to the hole portion 24-8 in the molding die for use in manufacturing the diffuser plate 16A-8 can be formed to be circular (columnar) in section, and therefore, the die strength can be kept high as compared with the case of the pins which are formed to be angular in section. Description of the structures (arrangements), operations and the like which are similar to those of the above described example 1 will be omitted.

### Example 9

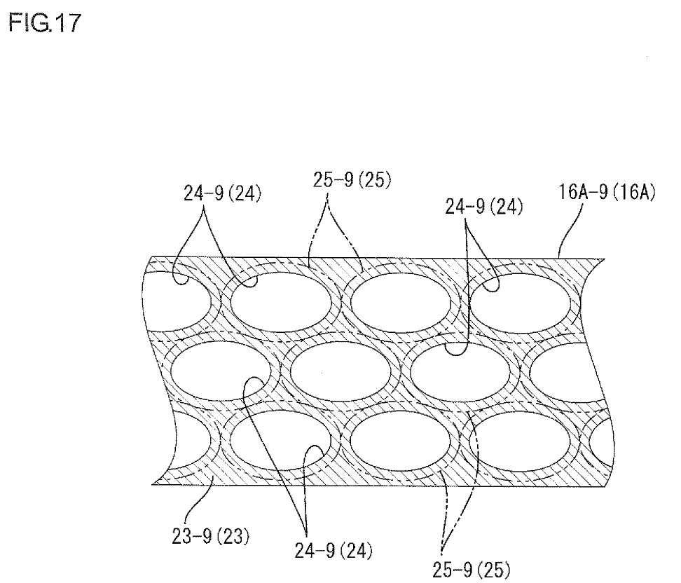

In a diffuser plate 16A-9 according to example 9, each tubular unit 25-9 (shown by the two-dot chain line of FIG. 17) forms a tubular shape which is elliptical in section, and the sectional shape of a hole portion 24-9 of it is formed to be elliptical as shown in FIG. 17. In more detail, the tubular unit 25-9 is formed so that a long axis direction of the elliptical hole portion 24-9 becomes parallel with the plate surface of the base member 23-9. Specifically, the sectional shape of the hole portion 24-9 is that of an ellipse which is laid.

In this manner, the base member 23-9 can be made thinner than the one in the above described example 8. Namely, the base member is preferable to a thin diffuser plate 16A-9. Description of the structures (arrangements), operations and the like which are similar to those of the above described example 1 will be omitted.

As described above, according to the present embodiment, the plate-shaped base member 23 capable of light transmission is constructed such that a plurality of tubular units 25 having the hole portions 24 are aligned in each of the planar direction and the thickness direction of the base member 23 and are connected to one another. Therefore, even when the base member 23 is increased in size, rigidity is sufficiently ensured by the regions remaining between the hole portions 24, and reduction in weight can be achieved by the amount corresponding to formation of the hole portions 24, whereby the diffuser plate 16A preferable for increase in size can be provided.

Further, the hole portions 24 in the respective tubular units 25 are formed into the same shapes, and the tubular units 25 are arranged to be aligned parallel with each other. Therefore, arrangement efficiency of the hole portions 24 in the base member 23 can be made favorable, which is preferable for further reduction in weight. Further, as compared with the one including the tubular units differing in shape from one another, and with the one including the tubular units non-parallel with each other, manufacture is facilitated.

Further, since the tubular units 25 aligned in the thickness direction of the base member 23 are arranged by being shifted in the planar direction from one another, the structure is such that the hole portions 24 are adjacent in the thickness direction to the region which is located between the hole portions 24 adjacent to each other in the planar direction in the base member 23. Thus, the rigidity can be kept high, and brightness unevenness hardly occurs when light is transmitted.

In addition, the tubular units 25 are arranged so that the intermediate positions between the tubular units 25 aligned in the planar direction of the base member 23 and the center positions of the tubular units 25 aligned in the thickness direction with respect to the tubular units 25 correspond to one another. Therefore, higher rigidity can be ensured, and brightness unevenness more hardly occurs when light is transmitted.

Further, the axial direction of the tubular unit 25 corresponds to the short side direction of the base member 23 which forms a rectangular shape, and as compared with, for example, the case where the axial direction of the tubular unit is caused to correspond to the long side direction of the base member, the length dimension of the tubular unit 25 can be shortened, and manufacture is facilitated.

Further, the tubular unit 25 has the hole portion 24 in the form penetrating through the base member 23, and therefore, air can be circulated in the base member 23.

Further, a number of diffuser particles are distributed in the base member 23 of the diffuser plate 16A, and the diffuser particles have the property which diffuses more lights in the short wavelength region among visible lights, but in the present embodiment, the thickness of the tubular unit 25 constructing the base member 23 depends on the space between the hole portions 24, and has nothing to do with the thickness dimension of the base member 23, and therefore, the problem that the transmitted light becomes yellowish with increase in the thickness dimension of the base member 23 can be avoided. Thereby, the display quality also can be kept favorable in the large liquid crystal display device D.

### Embodiment 2

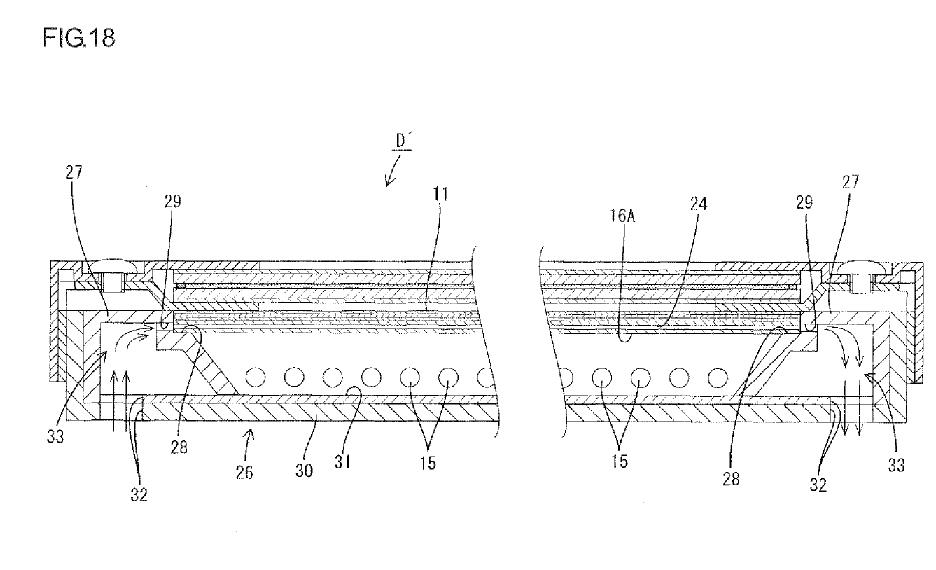

Embodiment 2 of the present invention will be described based on FIG. 18. Embodiment 2 shows the one including the function of removing heat from a diffuser plate. In embodiment 2, redundant description of the structures, operations and effects which are similar to the above described embodiment 1 will be omitted.

A communication opening portion 29 capable of communicating with each of the hole portions 24 of the diffuser plate 16A is provided in a support portion 28 of each holder 27 which receives an outer peripheral end portion (portion having an end surface to which each of the hole portions 24 opens) on the side of the long side in the diffuser plate 16A in a backlight 26, as shown in FIG. 18. An externally opening portion 32 which allows a space inside the holder 27 to open to an outside is provided in a portion mounted with the holder 27, in a chassis 30 and a reflective sheet 31. Accordingly, the hole portion 24 of the diffuser plate 16A communicates with an external space through a ventilation passage 33 constructed by the communication opening portion 29, the space in the holder 27, and the externally opening portion 32. By passing through the ventilation passage 33, external air can flow into the hole portion 24, and the air inside the hole portion 24 can flow outside.

When a liquid crystal display device D′ is used, the liquid crystal display device D′ is brought into the posture in which the short side direction (the axial direction of the tubular unit 25 and the hole portion 24, the opening direction of the hole portion 24) of the diffuser plate 16A corresponds to the vertical direction, and the holder 27 at the right side shown in FIG. 18, for example, is located at the upper side in the vertical direction, whereas the holder 27 at the left side in the drawing is located at the lower side in the vertical direction. In this state, the power supply of the liquid crystal display device D′ is turned ON, and each of the cold cathode tubes 15 is lit, whereby heat generates in each of the cold cathode tubes 15. The heat is transmitted to the diffuser plate 16A, and thereafter, is likely to be transmitted to the liquid crystal panel 11 side in a short time.

However, external air can flow into the hole portion 24 of the diffuser plate 16A through the ventilation passage 33. In more detail, when the diffuser plate 16A is warmed from the underside by the heat from the cold cathode tube 15, the temperature of the air in the hole portion 24 rises. Thereupon, an ascending current occurs in the hole portion 24, and the air in the hole portion 24 is caused to flow out (discharge, exhaust) outside through the communication opening portion 29 at the upper side in the vertical direction, the space in the holder 27 at the upper side in the same direction, and the externally opening portion 32 at the upper side in the same direction as shown by the arrows of FIG. 18. Meanwhile, air in the external space is caused to flow in (is taken in) from the externally opening portion 32 at the lower side in the vertical direction, and the air, which flows in, flows into the hole portion 24 through the space in the holder 27 at the lower side in the same direction, and the communication opening portion 29 at the lower side in the same direction. By performing such air circulation, removal of heat from the diffuser plate 16A is achieved. Thereby, heat transmission to the liquid crystal panel 11 is suppressed, and thereby, an adverse effect can be prevented from being exerted on the display quality. The number of the opening portions 29 and 32 which are installed, the installed positions, the sizes and the shapes of them can be properly changed.

### Embodiment 3

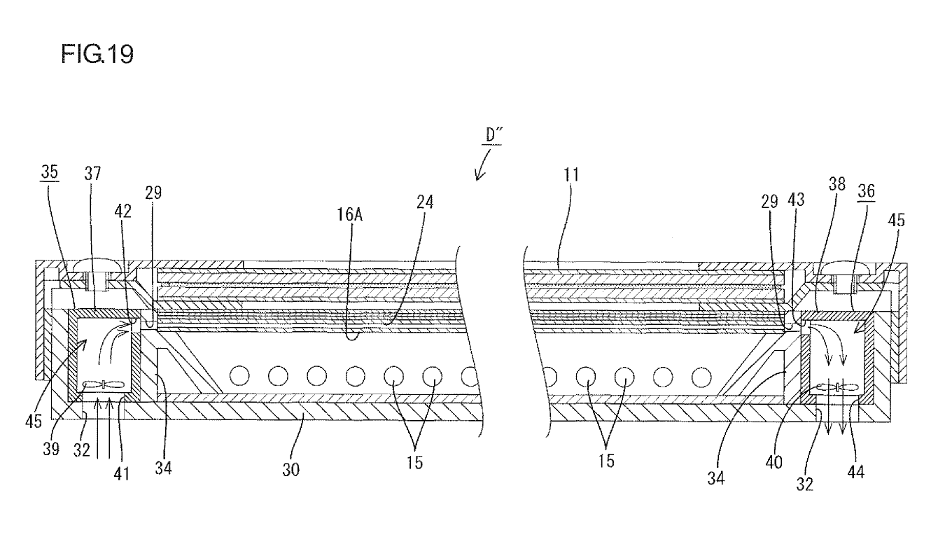

Embodiment 3 of the present invention will be described based on FIG. 19. In embodiment 3, what is reinforced in the heat removal function is shown. In embodiment 3, redundant description of the structures, operations and effects which are similar to those in the above described embodiment 2 will be omitted.

A pair of holder 34 and fan unit 35, and a pair of holder 34 and a fan unit 36 are respectively attached to both end portions along the long side direction of the chassis 30 as shown in FIG. 19. The fan units 35 and 36 are installed between the holders 34 and the side walls of the chassis 30, and are constructed by box-shaped cases 37 and 38, and fans 39 and 40 provided in the cases 37 and 38. Of both the fan units 35 and 36, the fan unit 35 which is arranged on the lower side in the vertical direction (left side shown in FIG. 19) at the time of use is used for intake, whereas the fan unit 36 which is arranged on the upper side in the vertical direction (right side shown in FIG. 19) at the time of use is used for exhaust.

An intake opening portion 41 which communicates with the externally opening portion 32 of the chassis 30 is provided in the bottom portion of the case 37 in the fan unit 35 for intake. Meanwhile, an exhaust opening portion 42 which communicates with the communication opening portion 29 of the holder 34 is provided in the side wall which is opposed to the holder 34 in the case 37. The fan 39 is installed directly inside the intake opening portion 41 in the case 37, and is capable of blowing the air which is taken in from the intake opening portion 41 toward the exhaust opening portion 42 as shown by the arrows of FIG. 19.

An intake opening portion 43 which communicates with the communication opening portion 29 of the holder 34 is provided in the side wall which is opposed to the holder 34 in the case 38 in the fan unit 36 for exhaust. Meanwhile, an exhaust opening portion 44 which communicates with the externally opening portion 32 of the chassis 30 is provided in the bottom portion of the case 38. The fan 40 is installed directly inside the exhaust opening portion 44 in the case 38, and is capable of blowing the air which is taken in from the intake opening portion 43 toward the exhaust opening portion 44 as shown by the arrows of FIG. 19.

In this manner, the hole portion 24 of the diffuser plate 16A communicates with an external space through ventilation passages 45 which are constructed by the communication opening portions 29, the externally opening portions 32, the intake opening portions 41 and 43, the exhaust opening portions 42 and 44, and the spaces in the cases 37 and 38. In addition, circulation of the air in the hole portion 24 can be promoted by the fans 39 and 40 installed in the ventilation passages 45.

At the time of use, the posture of a liquid crystal display device D″ is set so that the holder 34 at the right side shown in FIG. 19 is on the upper side in the vertical direction, whereas the holder 34 at the left side in the drawing is located on the lower side in the vertical direction, and the power supply is turned ON, whereby each of the cold cathode tubes 15 is lit. The diffuser plate 16A is warmed from the underside by the heat generated from each of the cold cathode tubes 15, but the air in the hole portion 24 of the diffuser plate 16A is circulated through the ventilation passage 45, whereby heat from the diffuser plate 16A is removed. In addition, by driving the intake fan 39 and the exhaust fan 40, external air is forcefully drawn into the intake case 37 and is blown to the hole portion 24 of the diffuser plate 16A, and the air inside the hole portion 24 is forcefully drawn into the exhaust case 38 and can be exhausted to the external space, whereby heat can be efficiently removed from the diffuser plate 16A. Thereby, heat transmission to the liquid crystal panel 11 is effectively suppressed, whereby an adverse effect can be reliably prevented from being exerted on the display quality.

Drive of each of the fans 39 and 40 can be synchronized with ON/OFF of the power supply of the liquid crystal display device D″. Other than this, such setting is possible that, for example, a temperature sensor (not illustrated) is installed in the chassis 30, and when the detected temperature is a set value or more, each of the fans 39 and 40 is turned ON, and when the temperature is lower than the set value, each of them is turned off. Further, the number of each of the fans 39 and 40, and the opening portions 29, 32, 41, 42, 43 and 44 which are installed, the installed positions, sizes and the shapes of them can be properly changed.

### Embodiment 4

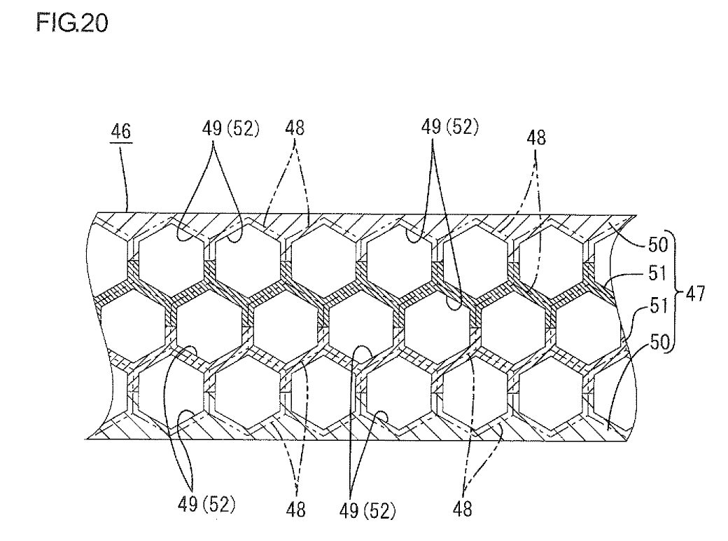

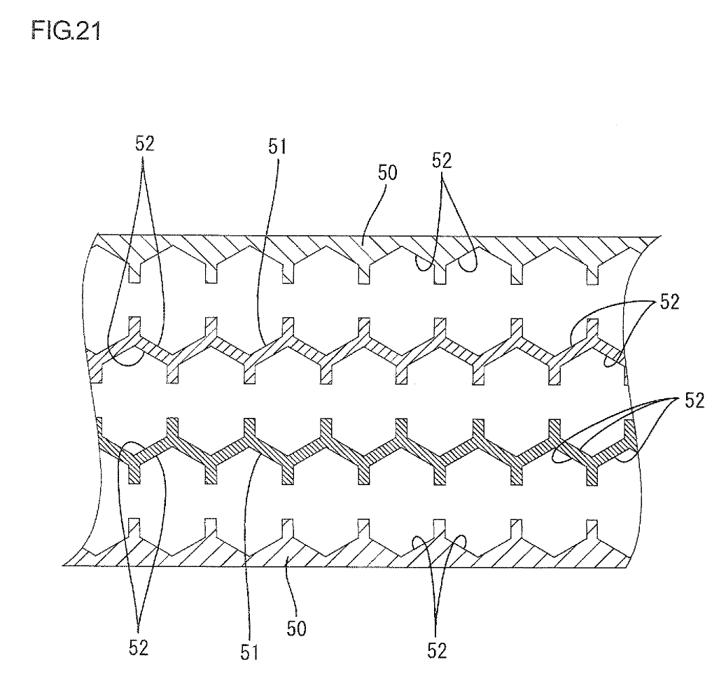

Embodiment 4 of the present invention will be described based on FIG. 20 or 21. Embodiment 4 shows the one with the manufacturing method of the diffuser plate being changed. In embodiment 4, redundant description of the structures, operations and effects which are similar to the above described embodiment 1 will be omitted.

A diffuser plate 46 according to embodiment 4 is the same as the one described in example 1 of the above described embodiment 1 in the shapes and arrangement of the respective tubular units 48 and hole portions 49 in a base member 47, but differs from embodiment 1 in the point of having a structure in which a plurality of (four in FIG. 20) sheet members 50 and 51 are stacked and bonded to each other as shown in FIG. 20. Each of the sheet members 50 and 51 has the configuration in which the respective tubular units 48 are cut in halves along the planar direction and those cut in halves are arranged in the planar direction and connected to one another, and on its surface, a number of recessed portions 52 each in the shape of the respective hole portion 49 cut in halves along the planar direction, are aligned and placed.

Of the respective sheet members 50 and 51, on both the sheet members 50 (both the sheet members 50 constituting the uppermost layer and the lowermost layer shown in FIG. 20) including the outer surfaces on the front and back of the diffuser plate 46, the recessed portions 52 are formed on only one surface, whereas on the two sheet members 51 sandwiched by these sheet members 50, the recessed portions 52 are formed on both surfaces. Both the sheet members 50 each with the recessed portions 52 formed on only one surface are formed into the same shape as each other. Further, both the sheet members 51 each with the recessed portions 52 being formed on both surfaces are formed into the same shape as each other.

The diffuser plate 46 of such a structure is manufactured as follows. Specifically, after the respective sheet members 50 and 51 are resin-molded by using molding dies, the respective members 50 and 51 are bonded to each other by an adhesive or the like while the respective members 50 and 51 are positioned with each other so that the recessed portions 52 of the respective sheet members 50 and 51 are opposed to one another as shown in FIG. 21, and thereby, the diffuser plate 46 as shown in FIG. 20 is obtained.

Incidentally, the recessed portion 52 formed in each of the sheet members 50 and 51 is in the form which opens along the planar direction of the diffuser plate 46, and also opens in the thickness direction of the diffuser plate 46. Accordingly, in the molding die used for resin-molding each of the sheet members 50 and 51, ribs (and the molding dies are not illustrated) in the shape corresponding to the respective recessed portions 52 are formed. The ribs are connected over the entire length to the wall surface along the planar direction of the sheet members 50 and 51 in the molding dies. Thereby, strength of the molding dies can be kept high, which is preferable for mass production, as compared with the molding die M for manufacturing the diffuser plate 16A of the structure as described in embodiment 1 having the pin Ma in the cantilever form (see FIG. 6).

### Embodiment 5

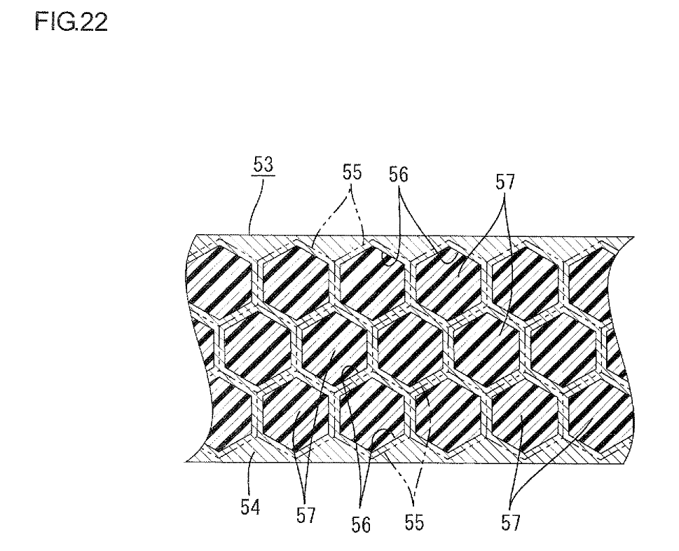

Embodiment 5 of the present invention will be described in accordance with FIG. 22. In embodiment 5, the one with the manufacturing method of the diffuser plate being changed is shown. In embodiment 5, redundant description of the structures, operations and effects similar to the above described embodiment 1 will be omitted.

A diffuser plate 53 according to embodiment 5 is the same as the one described in example 1 of the above described embodiment 1, in the shape and arrangement of each tubular unit 55 and each hole portion 56 in a base member 54, but differs from embodiment 1 in the point that a core 57 is inserted in a manufacturing process as shown in FIG. 22. The core 57 is formed from a material which is dissolved by a predetermined solvent.

Describing the manufacturing method of the diffuser plate 53 in more detail, a number of cores 57 each in the shape corresponding to the hole portion 56 are manufactured first, and the cores 57 are set in the molding die for resin-molding the diffuser plate 53. In this state, a synthetic resin in the a molten state is filled into the molding die, and when it is solidified, the molding die is opened, whereby the diffuser plate 53 in the state in which the cores 57 are inserted in the positions corresponding to the hole portions 56 is obtained. In this diffuser plate 53, the cores 57 are exposed to its end surface. Accordingly, when the diffuser plate 53 is soaked in the solvent thereafter, the cores 57 exposed to the end surface of the diffuser plate 53 are dissolved by the solvent, and thereby, the form in which the hole portions 56 open to the end surface of the diffuser plate 53 is made (See FIGS. 5 and 19). In this manufacturing method, the pins for molding the hole portions 56 do not need to be provided in the molding die for resin-molding the diffuser plate 53, and therefore, the structure of the molding die can be simplified.

As the concrete material of the core 57, a halide of alkali metal, a nitrate, acetate, sulfate and the like are cited. As the concrete example of the solvent, water, a mixed solution of alcohol and water, a mixed solution of a sodium hydrogencarbonate and water and the like are cited.

### Other Embodiments

The present invention is not limited to the embodiments described by the above description and drawings, and, for example, the following embodiments are also included in the technical scope of the present invention.

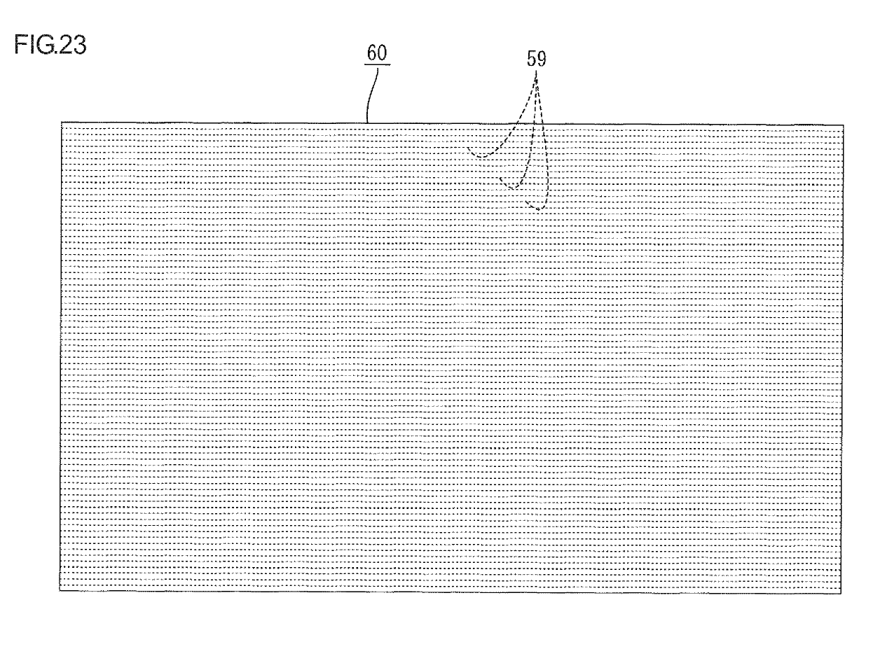

(1) Each of the above descried embodiments shows the one with the axial directions of the tubular unit and hole portion corresponding to the short side direction of the diffuser plate, but as shown in FIG. 23, the one with the axial direction of a hole portion 59 (tubular unit) corresponding to the long side direction of a diffuser plate 60 as shown in FIG. 23 is also included in the present invention.

(2) As another manufacturing method of the diffuser plate, a solid diffuser plate in which a hole portion is not formed, for example, is produced, and thereafter, a hole portion may be cut and formed in the end surface of the diffuser plate by a drill or the like.

(3) In each of the above described embodiments, the one in which all the tubular units (hole portions) in the diffuser plate are in the same shape and arranged to be aligned parallel with one another is shown as an example, but the one including a plurality of kinds of tubular units (hole portions) differing in shape, and the one including a plurality of kinds of tubular units (hole portions) differing in the orientation in the axial direction are also included in the present invention.

(4) In examples 1 to 7 of the above described embodiment 1, those having regular polygonal hole portions are shown as examples, but those having irregular polygonal hole portions are also included in the present invention. Further, the concrete shape of the hole portion can be arbitrarily changed other than those illustrated.

(5) In examples 1 to 7 of the above described embodiment 1, the cases in which the lines connecting the respective vertexes in the hole portion of the polygons are set as straight lines are shown as examples, but those in the shapes in which the respective vertexes are connected by curved lines such as arcuate lines are also included in the present invention. Further, those having hole portions in the shapes which are formed by cutting the corner portions of the polygons by the straight lines are also included in the present invention.

(6) In each of the above described embodiments, the one in which the intermediate position between the tubular units aligned in the planar direction and the center position of the tubular unit aligned in the thickness direction with respect to the tubular units correspond to each other is shown, but the one in which the above described intermediate position and the above described center position are shifted in the planar direction from each other is also included in the present invention.

(7) In each of the above described embodiments, the one in which the center position of each of the tubular units aligned in the planar direction and the center position of the tubular unit aligned in the thickness direction with that tubular unit are shifted in the planar direction, a so-called zigzag arrangement is shown, but the one in which the center positions of the tubular units aligned in the thickness direction correspond to each other is also included in the present invention.

(8) In each of the above descried embodiments, the one in which a number of diffuser particles are included in the base member of the diffuser plate is shown, but as long as the diffusion effect of light obtained by forming the hole portions is sufficient, the construction without including the diffuser particles may be adopted, and such a diffuser plate is also included in the present invention.

(9) In each of the above described embodiments, the diffuser plate is shown as an example of the optical member, but the present invention is applicable to the other kinds of optical members than the diffuser plate.

(10) in each of the above described embodiments, the case of showing the cold cathode tube as an example of the light source is shown as an example, but the present invention is also applicable to those adopting the other kinds of linear optical sources such as a hot cathode tube and a fluorescent tube, and a point light source such as an LED.

(11) In each of the above described embodiments, the liquid crystal display device using a liquid crystal panel as a display panel is shown as an example, but the present invention is also applicable to the display devices using the other kinds of display panels.

(12) In each of the above described embodiments, a television receiver including a tuner is shown as an example, but the present invention is also applicable to the display device without including a tuner.

(13) The case in which the diffuser particles included in the base member of the diffuser plate are evenly dispersed in the base member is naturally included in the present invention, but diffuser particles are dispersed by unevenly distributed in the vicinity of the surface of the base member (surface on the front side and the surface on the underside) in some cases, and such cases are also included in the present invention.

1. An optical member, comprising:
a plate-shaped base member capable of light transmission,
wherein the base member has a construction in which a plurality of tubular units having hole portions are aligned in each of a planar direction and a thickness direction of said base member and are connected to one another.

2. The optical member according to claim 1,
wherein said hole portions in said respective tubular units are formed into the same shape, and said respective tubular units are arranged to be aligned parallel with one another.

3. The optical member according to claim 2,
wherein said tubular units aligned in said thickness direction are arranged by being shifted in said planar direction from one another.

4. The optical member according to claim 3,
wherein an intermediate position between said tubular units aligned in said planar direction, and a center position of a tubular unit aligned in said thickness direction with respect to the tubular units are arranged to correspond to each other.

5. The optical member according to claim 4,
wherein said tubular unit has said hole portion which is substantially hexagonal in section.

6. The optical member according to claim 5,
wherein said tubular unit is formed so that a side edge of said hole portion is parallel with a plate surface of said base member.

7. The optical member according to claim 2,
wherein said tubular unit has said hole portion which is substantially triangular in section.

8. The optical member according to claim 2,
wherein said tubular unit has said hole portion which is substantially quadrangular in section.

9. The optical member according to claim 2,
wherein said tubular unit has said hole portion which is substantially circular in section.

10. The optical member according to claim 2,
wherein said tubular unit has said hole portion which is substantially elliptical in section, and said tubular unit in its long axis direction is formed to be parallel with a plate surface of said base plate.

11. The optical member according to claim 1,
wherein said base member is formed into a rectangular shape, and an axial direction of said tubular unit corresponds to a short side direction of said base member.

12. The optical member according to claim 1,
wherein said tubular unit has said hole portion in a form penetrating through said base member.

13. The optical member according to claim 1,
wherein in said base member, a number of diffuser particles are included by being dispersed.

14. An lighting device, comprising:
the optical member according to claim 1;
a chassis which is mounted with the optical member; and
a light source housed in the chassis.

15. The lighting device according to claim 14,
wherein said optical member has a structure in which said tubular unit has said hole portion in a form penetrating through said base member, and a ventilation passage which communicates with the hole portion is ensured.

16. The lighting device according to claim 15,
wherein the axial direction of said tubular unit is set to be parallel with a vertical direction in a use state.

17. The lighting device according to claim 15,
wherein said ventilation passage includes a blowing device capable of blowing air toward said hole portion.

18. A display device, comprising:
the lighting device according to claim 14; and
a display panel arranged on a front side of the lighting device.

19. The display device according to claim 18,
wherein said display panel is a liquid crystal panel formed by sealing liquid crystal between a pair of substrates.

20. A television receiver comprising:
the display device according to claim 18.
